(19) United States
(12) Patent Application Publication
(10) Pub. No.: US 2020/0387268 A1
(43) Pub. Date: Dec. 10, 2020

(54) DYNAMICALLY CUSTOMIZED APPLICATION SELECTION AND RECOMMENDATION SYSTEMS

(71) Applicant: United States Postal Service, Washington, DC (US)

(72) Inventors: James M. Shipman, Cary, NC (US); Steven D. Weatherford, Raleigh, NC (US); John T. Teal, Youngsville, NC (US)

(21) Appl. No.: 16/893,949

(22) Filed: Jun. 5, 2020

Related U.S. Application Data
(60) Provisional application No. 62/858,240, filed on Jun. 6, 2019.

(51) Int. Cl. G06F 3/0482; G05B 15/02

(52) U.S. Cl. CPC G06F 3/0482; G06Q 10/10; G05B 15/02

(57) ABSTRACT

Embodiments of a system and method for dynamic configuration of an application recommendation and display. A collection of applications can be tailored to the specific user, their role, and their permissions. The system can recommend specific applications to the user, rather than presenting an overwhelming catalog of, sometimes, irrelevant applications. The recommendations may be personalized for each user based on criteria related to the user's occupation code, manager, finance number, and usage of applications by other users. The recommendations allow users to quickly see which applications are popular to other users and allow them to add those applications to their device quickly, with few inputs to the system.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. This application claims the benefit of priority to U.S. Provisional Application No. 62/858240, filed 6 Jun. 2019, the entire contents of which are hereby incorporated by reference.

This disclosure generally relates to distributed application systems, including an application repository and/or toolbar, and in particular to dynamically customization and configuration of application availability and displays across an enterprise of devices.

The embodiments disclosed herein each have several aspects no single one of which is solely responsible for the disclosure's desirable attributes. Without limiting the scope of this disclosure, its more prominent features will now be briefly discussed. After considering this discussion, and particularly after reading the section entitled “Detailed Description,” one will understand how the features of the embodiments described herein provide advantages over existing systems, devices and methods for detecting and persisting rotation and region of interest for items in an automated processing system.

### BRIEF DESCRIPTION OF THE DRAWINGS

The foregoing and other features of the disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings.

FIG. 1 is a pictorial diagram of an embodiment of system for dynamically customized application recommendation and configuration.

FIG. 2A depicts an example image showing an exemplary application box that may be generated by the system shown in FIG. 1

FIG. 2B depicts an example image showing an exemplary application toolbar that may be generated by the system shown in FIG. 1.

FIG. 3A is a flow diagram illustrating an example method of dynamically customizing an application display or provision system.

FIG. 3B is a flow diagram illustrating an example method of generating application recommendations.

FIG. 3C is a flow diagram illustrating an example method of opening an application recommendation display.

FIGS. 4A through 4C depicts exemplary administration user interfaces.

FIG. 5 depicts an example image showing an application toolbar that may be generated by the system shown in FIG. 1.

FIG. 6 is a flow diagram illustrating an example method of dynamically customizing an application.

FIG. 7 is a block diagram of an embodiment of a computing device for customizing and configuring application toolbars.

### SUMMARY

In one aspect described herein, a computer-implemented method comprises under control of one or more processors, receiving, from a computing device, an application request, the application request including a user credential for a user of the computing device; identifying an attribute of the user based at least in part on the user credential; detecting an operational characteristic of the computing device; obtaining, from a first data store, application source information based at least in part on: (a) the attribute of the user, and (b) the operational characteristic of the computing device; and causing display, via the computing device, an interface comprising an application area for presenting a graphical indicator for an application, wherein a first interaction with the graphical indicator causes the computing device to access a application source identified by the application source information.

In some embodiments, the method further comprises detecting a status of the application; and causing display of a graphical overlay to the graphical indicator, the graphical overlay identifying the status of the application.

In some embodiments, the method further comprises detecting a status of a device controlled or monitored by the application; and causing display of a graphical overlay to the graphical indicator, the graphical overlay identifying the status of the device.

In some embodiments, obtaining, from a first data store, application source information based at least in part on: (a) the attribute of the user, and (b) the operational characteristic of the computing device comprises: detecting a lack of applications associated with a user account for the user; comparing the attribute and the operational characteristic of the computing device to attributes of other users having user accounts associated with the application; determining a first difference between the attribute and the attributes of the other users is less than a threshold difference; associating the application with the user account for the user; and providing the application source information for the application.

In some embodiments, the method further comprises detecting a placeholder value for a user attribute within the application source information; and replacing the placeholder value with a value of the attribute for the user.

In some embodiments, the placeholder value is a uniform resource locator parameter value.

In some embodiments, the placeholder value is a command line option value for an application installed on the computing device.

In some embodiments, the method further comprises detecting a placeholder value for a device attribute within the application source information; and replacing the placeholder value with a value of the operational characteristic for the computing device.

In some embodiments, the method further comprises identifying, via a second data store, a set of messages based at least in part on the attribute of the user, each message associated with a headline, content, and a sequence identifier; and causing display, via the computing device, an interface comprising a message area for presenting headlines included in the set of message based on sequence identifiers of respective headlines, wherein a second interaction with a headline causes the computing device to access content associated with the headline.

In some embodiments, the method further comprises recording a first time corresponding to the causing of display of the interface; detecting occurrence of a refresh time based on a comparison of the first time with a current time; identifying, via the second data store, a revised set of messages based at least in part on the attribute of the user; determining that the revised set of messages is different from the set of messages; and causing an update to the message area to terminate display of the set of messages and initiate display of the revised set of messages.

In some embodiments, the method further comprises detecting a status change for the application, wherein the status change indicates a change in the application source information; identifying, via the first data store, revised application source information; and causing an update to the application area such that the first interaction with the graphical indicator causes the computing device to access an updated application source identified by the revised application source information.

In some embodiments, the computing device is one of at least one hundred thousand computing devices in data communication with the one or more processors.

In some embodiments, the user is one of at least ten thousand users having access to the computing device.

In some embodiments, the application is one of at least one hundred applications having source information included in the first data store.

In some embodiments, the operational characteristic of the computing device comprises a peripheral device attached to the computing device.

In some embodiments, detecting the operational characteristic comprises transmitting a peripheral request to the computing device; and receiving a message from the computing device including the operational characteristic of the computing device.

In another aspect described herein, a system for using computer applications comprises a user interface configured to receive, from a user's computing device, an application request, the application request including a user credential for a user of the computing device; a server in communication with the user interface, the server configured to: identify an attribute of the user based at least in part on the user credential; detect an operational characteristic of the computing device; obtain, from a first data store, application source information based at least in part on: (a) the attribute of the user, and (b) the operational characteristic of the computing device; and cause display, via the user interface, an application area for presenting a graphical indicator for an application, wherein a first interaction with the graphical indicator causes the computing device to access a application source identified by the application source information.

In some embodiments, the server is further configured to query a second data store, using the attribute of the user, a set of messages, each of the set of messages being associated with a headline, content, and a sequence identifier; and cause display, via the user interface, a message area for presenting headlines included in the set of message based on sequence identifiers of respective headlines, wherein a second interaction with a headline causes the computing device to access content associated with the headline.

In some embodiments, the server is further configured to detect a status of the application; and cause display of a graphical overlay to the graphical indicator, the graphical overlay identifying the status of the application.

In some embodiments, the server is further configured to detect a status of a device controlled or monitored by the application; and cause display of a graphical overlay to the graphical indicator, the graphical overlay identifying the status of the device.

### DETAILED DESCRIPTION

To support the operations of large organizations, such as the United States Postal Service, hundreds of sophisticated applications may be deployed. Such organizations may have thousands of unique users. However each user may not need each of the hundreds of applications to perform their role in the organization. One management solution is to install, configure, and maintain the applications to all user workstations. This solution faces several significant technical hurdles. First, the amount of resources needed for an application is multiplied by each user workstation. This may also be accompanied by resources needed to acquire and maintain licenses for each instance of the application. Furthermore, if any change is made to the application, the change would need to be propagated to every user.

A further concern relates to discovery. With hundreds of applications installed, any given user within the enterprise may not identify the appropriate tools to perform their role. Furthermore, if a workstation is used by different users with different access permissions, some applications may be restricted for one user by permitted for another. This creates further resource overhead to manage and maintain the applications.

In the dynamic systems and methods described, users may have access to an application box, store, or toolbar, according to the users' job function, level of authority, applications of related users, and the like. The applications available in the application box or for the toolbar can be added based on requests as well as applications that can be searched for from within the computer environment. The application box and the toolbar can each represent a collection of applications tailored to the specific user, their role, and their permissions. The application engine may include features to recommend specific applications to the user, rather than presenting an overwhelming catalog of sometimes irrelevant applications. The recommendations may be personalized for each user based on criteria related to the user's occupation code, manager, finance number, and usage of applications by other users. The recommendations allow users to quickly see which applications are popular to other users and allow them to download, install, access, store, and/or add those applications to their toolbar quickly, with few inputs to the system.

For example, the task of navigating a large electronic catalog of applications to locate those applications suitable for the user's tasking can be burdensome and time consuming. This can be particularly acute in systems that include a wide spectrum of applications to support a highly diverse set of functions (e.g., mail sorting, accounting, legal services, human resources, security, etc.). Typically, a user can locate applications by a navigating aid such as a hierarchical “browse tree,” in which the applications are arranged by category and subcategory. Typically, however, the browse tree includes several levels of categories, requiring the system to present a complex display of categorized applications and receive and respond to inputs from a user to navigate through several levels of browse nodes or category pages. Each navigation action may be associated with a network request and response to obtain the relevant applications to present to ultimately arrive at the subcategory of interest. Thus, a user frequently has to perform numerous navigational steps to identify an application of interest.

Recommendation algorithms and user interfaces of the type disclosed herein significantly reduce this problem, allowing users to locate applications of interest with fewer steps. Each application recommendation can serve as a programmatically selected navigational shortcut to view or install an application to a user's workstation, application menu, personalized application toolbar, or similar location. The user can thus bypass traditional navigational structures such as a browse tree without a priori search knowledge (e.g., application taxonomies, categorizations, keywords, etc.). This can be particularly true for computing devices with limited resources (e.g., small screens, limited power or network bandwidth), where fewer items can be efficiently displayed to the user at a time and thus navigation of larger volumes of items is more difficult.

In the following detailed description, reference is made to the accompanying drawings, which form a part hereof. In the drawings, similar symbols typically identify similar components, unless context dictates otherwise. Thus, in some embodiments, part numbers may be used for similar components in multiple figures, or part numbers may vary depending from figure to figure. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and made part of this disclosure.

Reference in the specification to “one embodiment,” “an embodiment,” or “in some embodiments” means that a particular feature, structure, or characteristic described in connection with the embodiment is included in at least one embodiment of the invention. Moreover, the appearance of these or similar phrases throughout the specification do not necessarily all refer to the same embodiment, nor are separate or alternative embodiments necessarily mutually exclusive. Various features are described herein which may be exhibited by some embodiments and not by others. Similarly, various requirements are described which may be requirements for some embodiments but may not be requirements for other embodiments.

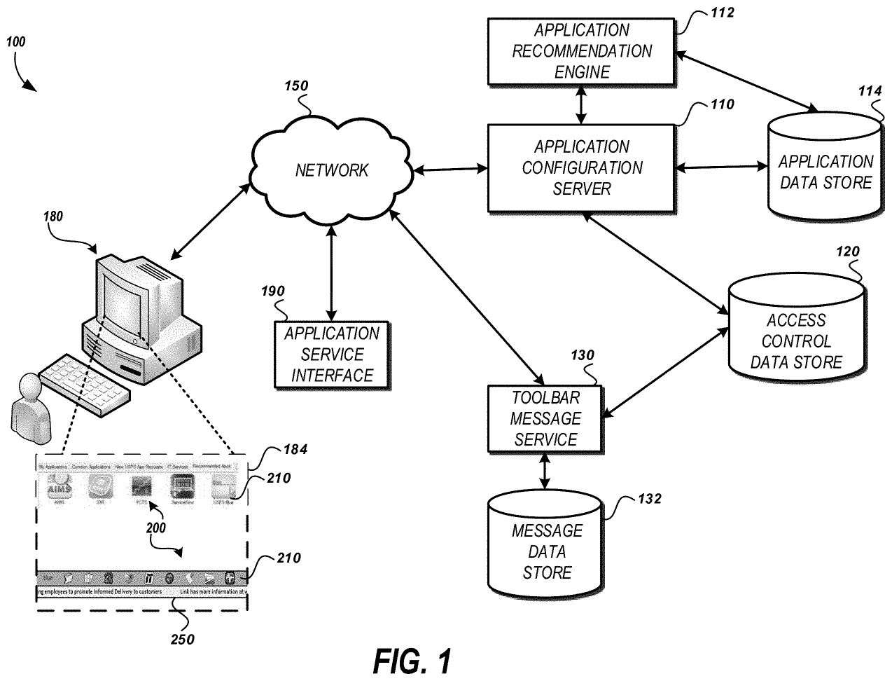

FIG. 1 is a pictorial diagram of an embodiment of an environment including dynamically customized application systems. The environment 100 may include thousands of workstations such as a workstation 180. The workstation 180 may be configured to support a variety of functions. The workstation 180 may include applications that are stored in a memory of the workstation 180. The workstation 180 may include accessing applications via a network 150. The networked application may provide an application service interface 190 to communicate with the workstation 180 to perform a task. Example tasks include adjusting an apparatus, such as item processing equipment (e.g., physical item sorting device, a scanning device), applying or altering security settings (e.g., credentials, collection of biometrics, etc.), or troubleshooting a function of the workstation 180. In some embodiments, the workstation 180 can be a mobile computing device, such as a mobile delivery device, tablet computer, and the like.

As discussed, the number and types of users of the workstation 180 may be varied. Accordingly, the tasks performed may exponentially alter the possible applications and configurations of the applications for a user. The workstation 180 may include a display 184 for presenting an application display 200, such as an application box or store, or a toolbar. An application box can be a display or window which displays icons associated with applications that have been selected, recommended, displayed, etc., based on the recommendation and customization processes described herein. The application box can be accessed by a user to download the relevant applications to a user's computing device, such as a workstation or mobile computing device. The application display 200 may include an application area 210 for presenting control elements associated with applications in the application box or on the toolbar, selected for the user accessing the workstation 180. The application display 200 may include a messaging area 250 for presenting messages relevant to the user accessing the workstation 180. The messaging area 250 may present messages in a stream such as via side scrolling or vertical transitions between messages. The application display 200 may be an application executing on the workstation 180 and shown on a portion of the display 184 of the workstation 180.

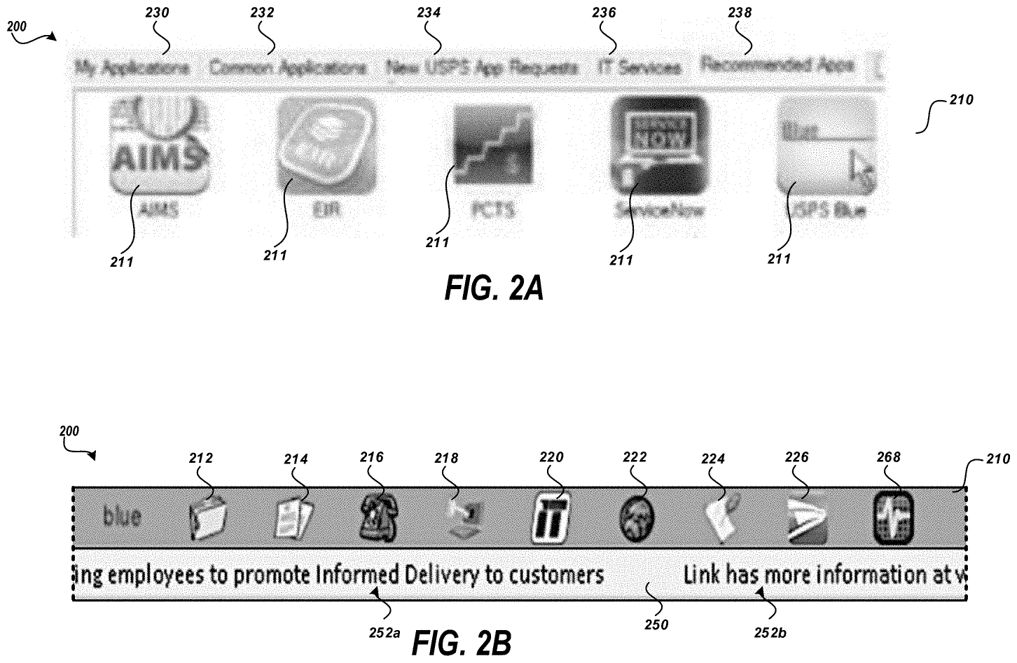

FIG. 2A depicts an example image showing an application display 200 that may be generated by the system of FIG. 1. The application display 200 can be an application box or application store. The application area 210 shown in FIG. 2A includes icons 211 identifying applications that can be accessed, downloaded, installed, requested, etc. The application box can have several tabs. In some embodiments, the application box can have a “My Applications” tab 230, a “Common Applications” tab 232, a “New App Request” tab 234, an “IT services” tab 236, and a “Recommended Apps” tab 238. These tabs are exemplary only, and any combination of the tabs listed here, in addition to other tabs not described here, can be used without departing from the scope of the current disclosure. FIG. 2A depicts the “Recommended Apps” tab 238 as being selected.

The “My Applications” tab 230 can list the applications which are already selected, or which have been previously installed. The “Common Applications” tab 232 can include a list of applications that are commonly used, or which are common to many different or disparate users.

The “New App Request” tab 234 can display the most recently added applications in the distribution network. The “IT services” tab 236 can provide quick access to IT related applications, including troubleshooting and error reporting applications. The “Recommended Apps” tab 238 can be the location to display the applications having a relevance ranking above the threshold identified in decision state 314. For each of the tabs, the application configuration server 110 can display a ranked list of applications, ranked by the number of users who have installed a given application, regardless of job responsibility, title, role, location, etc. In some embodiments, the application configuration server 110 can provide lists of only those applications to which the requesting user has access. In some embodiments, the application configuration server 110 can provide a ranked list of only those applications which have been installed by other users having the same or a similar job title, role, or responsibility.

FIG. 2B depicts an example image showing an application menu, window, or toolbar that may be generated by the system shown in FIG. 1. The application area 210 shown in FIG. 2 includes nine different graphical indicators—indicator 212, indicator 214, indicator 216, indicator 218, indicator 220, indicator 222, indicator 224, indicator, 226, and indicator 268. The indicator may be received via the network 150. An indicator may also be associated with a service or application. For example, if the indicator identifies an online item processing machine status system, the indicator may cause initiation of a browser-based application to view a specific page of the online item processing machine status system. The initiation may be based on a URL and may, in some instances, include parameters specific to the user. For example, it may be desirable to provide the user's location to cause the online item processing machine status system to present a status or operational information for processing machines at the facility the user is tasked to monitor. The application source information may include a placeholder value that can be substituted with a specific value identified for the user or the workstation associated with the user. For example, the application source information may include a URL with parameters. A parameter value may be updated to a value included in the user's credential (e.g., role or location) or obtained using the user's credential. As another example, the application source information may include a command line option to an application installed on the workstation. The command line option may include a placeholder value that can be replaced with a specific value for the user or the workstation associated with the user. An indicator may be associated with a particular application installed on the workstation 180. In such instances, an interaction with the indicator may cause execution of an application at the specified location (e.g., C:\program files\common\usps\peripheral-calibrator.exe).

The messaging area 250 of the application display 200 may include one or more messages for the user. As shown in FIG. 2, a portion of a first message 252a and a portion of a second message 252b are shown. The messages may scroll across the application display 200. A message may be an interactive message. An interactive message may be activated to cause the workstation 180 to retrieve and present additional or alternative content associated with the message. For example, if a message may be included in the messaging area 250 stating “New emergency evacuation procedures in place. Please review today.” The text may be clicked or otherwise interacted with to cause display of a video of the new evacuation procedures. A message service 130 may be provided to receive and respond to requests for messages. In some embodiments, the messages can be delivered on a mobile computing device, via a toolbar, on a screen, in a message service, etc. The messages may be retrieved from a message data store 132. The messages may also be associated with distribution permissions indicating users, roles, locations, or other attributes of users to whom the message can be displayed. A user credential may be included in a request for messages and used to obtain the attributes of a user from the access control data store 120. In some implementations, the message request may be received as a separate request from the workstation 180. In some implementations, the message request may be received from the application configuration server 110. In such implementations, the workstation 180 may only submit a single request to obtain applications and messages rather than submitting separate requests to the application configuration server 110 and message service 130.

The application display 200 may communicate via the network 150 to identify which applications to include in the application area 210, configuration options for the applications included in the application area 210, and obtain messages and a sequence for the messages to present in the messaging area 250. A application configuration server 110 may be included in the environment 100 to receive requests for applications to present via the application display 200 and configurations for applications presented via the application display 200. A request may include information identifying the workstation 180 or an operational characteristic of the workstation such as a capability of the workstation 180 (e.g., processor, operating system, attached peripherals (e.g., scanner, sorter, etc.)), physical or network location of the workstation 180, a state for the workstation 180 (e.g., power mode, processor load, network bandwidth, memory used, available memory), a user logged into the workstation 180, or a credential for the user logged into the workstation 180. The operational characteristic may be detected by the application configuration server 110. The detection may include transmitting a request (e.g., a peripheral request) to receive the operational characteristic from the workstation 180. The information included in the request may be used to identify applications selected by a user that can be executed on the workstation 180. The applications and configurations for applications may be stored in an application data store 114. In the case of the USPS, the application data store stores over 430 different applications. Information about a user such as their location, role, job description, access permissions, level of authorization, status as a manager, job location, and the like may be stored in a access control data store 120. The access control data store 120 may be the same source used to authenticate a user's access to the workstation 180. In some embodiments, the access control data store 120 includes access control logic configured to request permissions or confirm permissions from systems external to the environment 100. In some embodiments, the access control data store 120 can send an access request to a server on which a particular application is running, or which governs the application. In some embodiments, the access control data store 120 is in communication with a central access control system maintained by the distribution network, such as the USPS.

In some embodiments, an application can be selected, accessed, or installed by a user without a security check on the user credentials. In some embodiments, access to some applications is controlled, and can only be accessed by qualified or authorized users. The access control data store 120 can provide an access request to an access granting system, which can be part of the access control data store 120, or can be a separate service. If a user requests an application that requires a certain credential to access, the application configuration server 110 and the access control data store 120 can automatically pass the user's credentials to the access granting system, and can record a registration of permission to access the application.

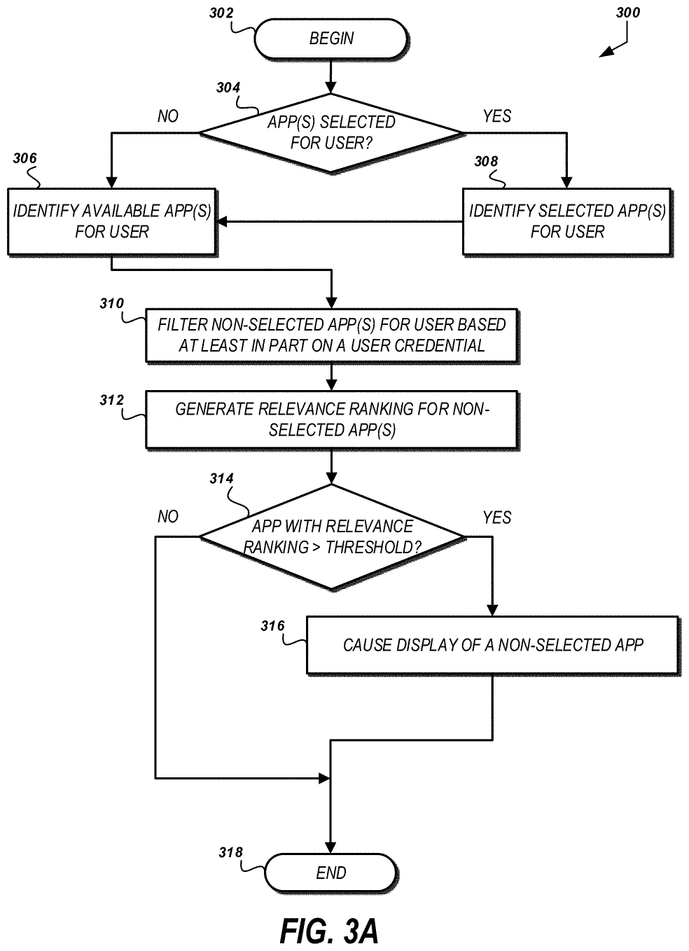

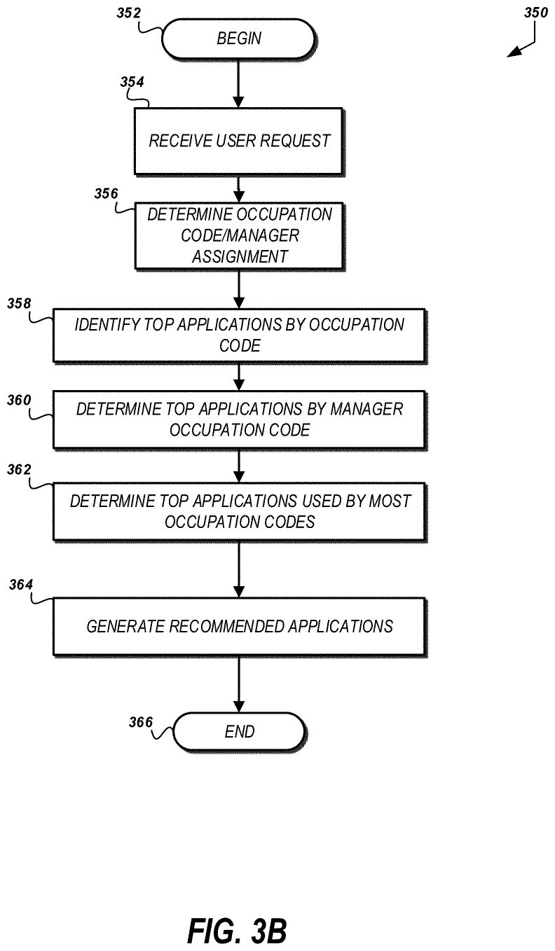

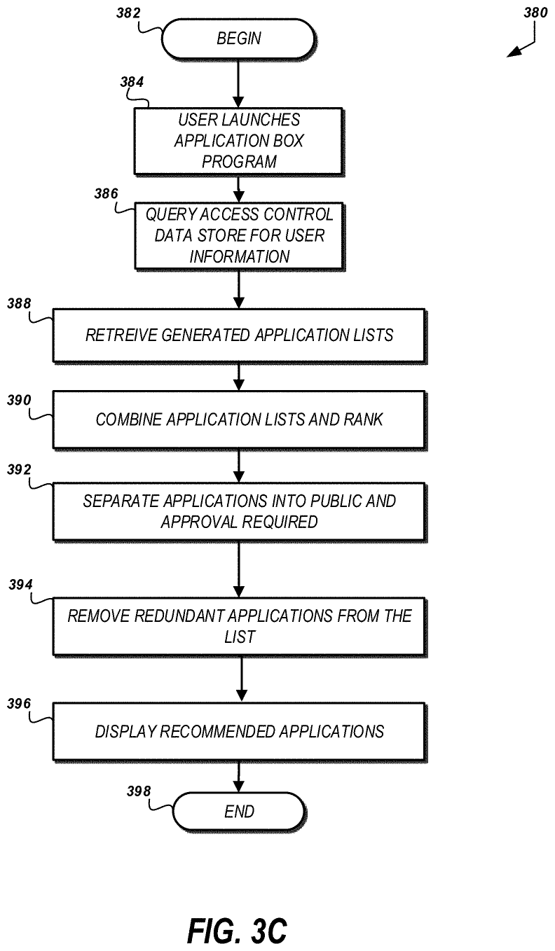

An application recommendation engine 112 may be included in the environment 100. The application recommendation engine 112 may be configured to identify one or more applications or configurations included in the application data store 114 for the application display 200 of a user at the workstation 180. For example, if a user access the workstation 180 for the first time, the user may not have selected any applications for the application display 200. In such instances, when the application configuration server 110 receives a request for the user at the workstation 180, upon determining no applications are selected for the user, the application configuration server 110 may request recommendations for the user from the application recommendation engine 112. Example methods of identifying recommended applications are discussed with reference to FIGS. 3A-3C.

FIG. 3A is a flow diagram illustrating an example method of dynamically customizing an application box, application menu, workstation, or application toolbar. The method 300 may be performed or coordinated in whole or in part by a coordination device such as the application configuration server 110 shown in FIG. 1. The method 300 may begin at block 302. The method may begin when a user logs into a workstation and a request to display an application menu, application selection function or application toolbar is received such as by an application configuration server. In some implementations, the method 300 may be used to identify applications automatically upon a user's first access to the system. In some embodiments, the identified applications can automatically be downloaded to a user's workstation, or can be added to an application menu without additional user action. This automatic downloading can occur at any point during the process 300.

At block 304, the coordination device may determine whether the user for whom the application request was made has selected applications. For example, if the user is a returning user, the user may have previously selected a set of applications. The selection may be stored in a user account data store. The request for the applications may include a user credential which identifies the user and can be used to query the user account data store. In some embodiments, the application recommendation engine 112 can use this information to exclude the user's previously installed, stored, or used applications from being displayed in the application display, for example, in the application box.

If the determination at block 304 is affirmative, the coordination device may, at block 308, identify the selected applications for the user. The identification may include receiving one or more identifiers for the applications associated with the user's account.

After identifying the selected application or if the determination at block 304 is negative, at block 306, the coordination device may identify recommended applications for the user. The identification may include retrieving attributes of the user associated with the toolbar request. The attributes may include organizational role information, demographic information, workstation capabilities, location, and the like. The attributes may be used to identify applications that are accessible by the user, which will be useful to the user's job functions, and/or are able to be executed using the hardware of the workstation. The identification may include locating applications that other users with similar roles, permissions, location, or other attributes have selected. The identification may include identifying applications that are most used by system users or a set of system users similar to the user or which are relevant to the geographic location of the user. Thus the selections of similar users may be used to identify new or alternate applications to display to the user.

In some embodiments, the available apps for the user may be determined based on user attributes. In some embodiments, the user attributes can include the capabilities of the user's workstation, computer, mobile computing device, etc. The capabilities of the user's workstation can be considered in this process and in other processes described herein. The user's workstation capabilities can be used as the only factor in determining available applications, or in conjunctions with other factors described herein.

At block 310, the coordination device may filter applications that are applicable to the user attributes but not currently associated with the user's account (e.g., selected). The filtering may also include removing applications from consideration that the user does not have permissions to access.

At block 312, the coordination device may generate a relevance ranking for the applications remaining after the filtering at block 310. The relevance ranking may be based on the quality of a recommendation. For example, several attributes may be used to identify applications: user location, user job role, and applications of related users. The proximity of the user location or user job role to an average location and role of other users of an application may be used to generate a relevance ranking for the toolbar application. The number of similarly situated users who have used, selected, or installed an application can also be factored into the relevance ranking. For example, if the user is a manager of a delivery facility, an application that is frequently used, selected, and/or accessed by other delivery facility managers would be given a higher weight in the relevance ranking than an application which is rarely used by delivery facility managers. An application that is frequently used by counter clerks would be given lower weight in a relevance ranking for a delivery facility manager. Each application provided at block 312 may be associated with a relevance ranking for the user requesting the applications, such as by opening an application box on their workstation 180.

At block 314, the coordination device may determine whether an application having a relevance ranking above a minimum threshold exists. For example, it may be desirable to make a recommendation when the strength of the recommendation is higher than the threshold. In some implementations, it may be desirable to provide the toolbar application associated with the highest relevance rating. In such implementations, a recommendation may always be provided even if the recommendation does not meet a minimum threshold.

In some embodiments, the coordination device can provide a list of most relevant applications. For example, the coordination device can display the 20 applications with the highest relevance ranking.

In the method 300 of FIG. 3A, if an application with a relevance ranking above the minimum threshold does not exist, the method 300 may end at block 318. Ending in this fashion would leave a recommendation area of the application display 200 empty. However, if the determination at block 314 is affirmative, at block 316 the coordination device may cause presentation of the applications associated with the relevance ranking. The presentation may include transmitting an identifier for the application for display in a recommendation area of the application display 200, such as in the “Recommend Apps” tab 238. The method 300 may then end at block 318, having provided at least one recommended application to the user that meets a minimum relevance for the user and/or workstation attributes. In some implementations, providing the recommendation may include automatically installing and/or configuring the application menu, desktop, file structure, or application list, or similar feature on the workstation of the user.

In some embodiments, when an application is identified, but the workstation of the user is not capable of running the identified or requested application, the coordinating device can automatically provide a software update to the user's workstation (computer, mobile device, etc.). In some embodiments, for example where the workstation is a mobile computing device, the coordinating device can notify the user that the hardware is incompatible for the requested or identified application. In some embodiments, the coordinating device can identify another workstation, for example, another mobile computing device which is compatible with the identified or requested application. The coordinating device can load the application to the compatible workstation, or can allow the compatible workstation to access the application. In some embodiments, the coordinating device can alert the user to access or use another workstation. The coordinating device can indicate an identifier, such as a serial number or location of a workstation that is capable to run the identified or requested application. In some embodiments, the coordinating device can trigger replacement of the user's current workstation with a workstation that can access and/or run the requested or identified application. This feature can be applicable to other processes described herein in addition to process 300.

FIG. 3B depicts an exemplary method for generating recommendations. The process 350 begins in block 352. The process 350 moves to block 354, wherein a request from a user to generate recommendations. In some embodiments, the process 350 may be performed routinely or at a given periodicity or when a threshold number of new applications is added to the environment 100. The process 350 need not be initiated by a specific user request.

The process 350 moves to block 356, wherein occupation codes and manager assignments are determined for the requesting user. The occupation code and manager assignments can be determined for an individual, such as if an individual requests to open the application box, or can be determined generally for all employees, for a subset of employees, for a geographic region, for a department or division within the distribution network, and the like. Occupation codes can be assigned to employees, managers, supervisors, and the like, and can be specific to a job task, a job assignment, etc., and can be unique for individual positions within the distribution network. In some embodiments, the occupation code can have more than one field or digit, where one field or digit identifies a department or division, another digit or field identifies a particular facility, and another field or digit identifies the job assignment. In this way, occupation codes can be used to identify geographic regions, departments, and other information about a particular employee, supervisor, manager, etc. In some embodiments, an occupation code can correspond to a job category or job type without having a geographic or facility specific component.

The correspondence between a user and a manager can also be obtained. This can be part of a directory or hierarchy of employees within a facility, or at any other level of the distribution network.

The process 350 moves to block 358, wherein the top applications by occupation code are identified. In some embodiments, the coordination device can identify, for each occupation code, the top applications downloaded, selected, and/or used by all users having a specific occupation code. In some embodiments, the coordination device can identify the top applications for portions or segments of the occupation code. For example, where the occupation code includes a facility component, a geographic component, a department component, etc., the top applications for occupation codes having the specific component can be identified.

The process 350 moves to block 360, wherein the coordination device determines the top applications for a particular manager or for a manager's occupation code. The manager's occupation code and the correspondence between the user and the manager can be used to generate a list of the top applications used, accessed, selected, installed, etc., by all users associated with a particular manager.

The process 350 moves to block 362, wherein the controlling device determines the top applications used by the most occupation codes. That is, all the applications in the environment 100 can be associated with the occupation codes for all the users using those applications. The applications which are used by the highest number of occupation codes can be identified. In some embodiments, the applications which are used by the highest number of users can be identified. In some embodiments, applications having the highest number of occupation codes and the highest number of users can be determined and provided.

In some embodiments, blocks 358, 360, and 362 can be performed in parallel, or any sub-combination blocks 358, 360, and 362 can be performed in any order desired, without departing from the scope of this disclosure.

The process 350 moves to block 364, wherein, lists, collections, categories, reports, etc. of recommended applications are generated. The recommended applications can be categorized in one large category, and/or can be divided or split into groups. In some embodiments, the recommended applications can be divided into groups including one list or document of recommended applications for each occupation code; a list or document of recommended applications for each manager; a list or document of recommended applications based on geography, department, facility, etc. In some embodiments, the recommended applications can be provided in one list or document which lists the top applications overall. It will be understood that the recommended applications can be generated and/or listed in a variety of categories without departing from the scope of this disclosure.

The process 350 moves to block 366, where the process 350 ends.

FIG. 3C depicts an exemplary method for providing recommendations to a user, such as in an application box or application store, or for selection to add to a menu, a desktop, a mobile device, a toolbar, or the like. A process 380 begins in block 382. The process 380 moves to block 384, wherein a user launches an application box program, such as accessing an application store, a dedicated application, or requests recommendations for inclusion in a toolbar.

The process 380 moves to block 386 wherein the coordinating device queries the access control data store for user information. The query for user information can be similar to those described elsewhere herein. In some embodiments, the user information can include job title, job description, user credentials, etc.

The process 380 moves to block 388, wherein the coordinating device retrieves generated recommended application lists. The retrieval can be based on the user access information from the access control data store. The application lists or documents can be similar to those described with regard to process 300 and process 350.

The process 380 moves to block 390, wherein the retrieved recommended application lists are combined and ranked according to the user access information. In some embodiments, the coordinating device can pull recommended applications from several list categories described above, and can mix or use portions of the lists or documents based on user information, such as occupation code, location, job title, etc. The combined applications can be ranked according to a preset criteria, such as one associated with the user's occupation code, or based on a user input. For example, a user may select a particular category or criteria for displaying recommended applications.

The process 380 moves to block 392, wherein the retrieved recommended application lists are separated or split into application categories, including public applications and approval required applications. Public applications can be those applications which are accessible to any person in the distribution network, or within an organization. Approval required applications can be those applications which are not accessible to everyone, but require specific access authorization. In some embodiments, these applications can be applications used by management or supervisory personnel, human resources, some IT applications, etc. In some embodiments, a third party contractor may have access to the application box, and can have access to public applications, but would not have access to authorization required applications, unless specifically authorized.

The process 380 moves to block 394, wherein the coordinating device removes redundant applications from the list. Where the user has already installed a particular application on a computing device, or when a user already has access or authorization for an application, the coordinating device can remove those applications from the list of recommended applications. Additionally, if the user has already placed applications in a tab, such as in the custom tab, the coordinating device can remove these selected applications from the list of recommended applications.

The process 380 moves to block 396, wherein the coordinating device displays the recommended applications in the application box or application store. The display of the recommended applications can be separated into public and authorization required lists. A user can then select an application from the recommended application list in the application box or application store. If the application requires authorization, the coordinating device can send the users credentials, occupation code, etc., to a central access control system, which can grant or deny access according to the user's credentials, etc.

The process 380 moves to block 398 and ends.

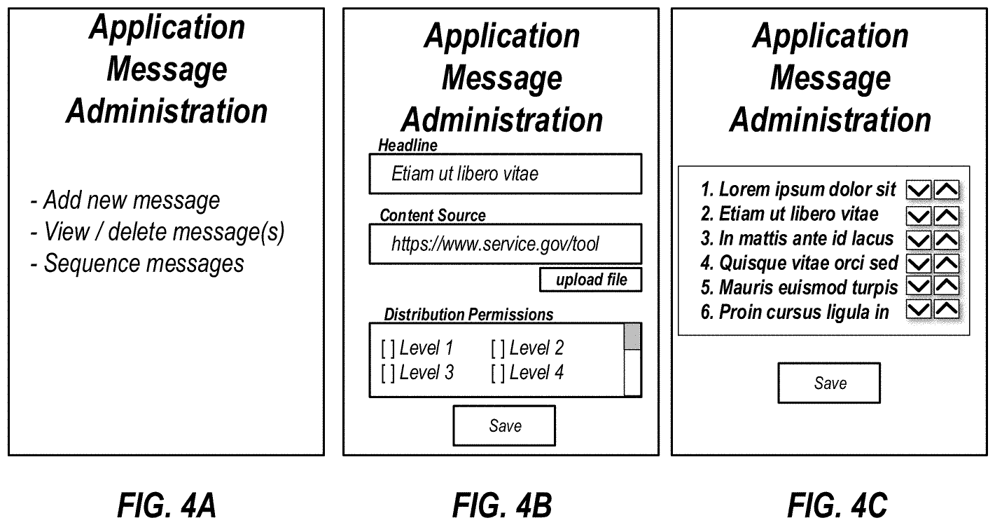

FIGS. 4A through 4C depict example message administration user interfaces. FIG. 4A shows an initial administration interface which includes a menu of actions that a user can perform. As shown in FIG. 4A, the actions are “Add new message”, “View/delete message(s)”, and “Sequence messages.” An action may be interacted with (e.g., click, tap, select, etc.) to initiate display a user interface to perform the selected action.

Activating an interface control element to add a new message may cause display of a message editing interface such as shown in FIG. 4B. The message editing interface may include control elements for receiving input to define a message for display in the application display 200. The input may include a text field for receiving a headline for the message. The headline may represent the text that is presented in the messaging area 250 of the application display 200. When the headline is interacted with, content may be presented. The message editing interface may include a control element to receive the content (e.g., multimedia file, text, etc.) or information identifying the content source (e.g., network location or application installation location). The message editing interface may include a control element to identify distribution permissions for the message. The distribution permissions allow the administrator to control which users will be presented the message. For example, if the message relates to an executive function or to users at a specific site, it may be desirable to limit distribution of the messages to users associated with the executive role or located at the specific site. When editing is complete, a save button or other control element may be activated to store the message in the message data store 132.

If the message editing interface in FIG. 4B is activated in response to an add message action, the fields may be empty. In some implementations, an existing message may be edited using the message editing interface. To select a message for editing, a message selection interface may be provided such as shown in FIG. 4C.

The message selection interface may provide a listing of messages available for display via the application display 200, such as in the toolbar. The message selection interface may display the headline of messages. A headline may be activated to cause display of the message editing interface (e.g., FIG. 4B) for editing the message associated with the headline. As shown in FIG. 4C, each message may be associated with a sequence toggling control element. In FIG. 4C the sequence toggling control element includes an up button and down button. Activating the up button moves a message up the sequence of display. Activating the down button moves a message down the sequence of display. The sequence of the messages controls the order in which headlines are organized within the application display 200. A sequence identifier may be used to indicate the position of a headline within a set of messages. When editing is complete, a save button or other control element may be activated to store the message sequence in the message data store 132.

Although not shown in FIG. 4C, the message selection interface may include a filter control element to identify specific messages for sequencing or editing. For example, an administrator may wish to view all active messages for postal carriers. This user role may be selected and, upon selection, the user interface shown in FIG. 4C updated to show a sequence of headline for messages associated with the distribution group of postal carriers.

In some embodiments, the messages described with regard to FIG. 4A-4C can be displayed on a toolbar embodiment of an application display 200, and may not be displayed in the application box embodiment of the application display 200. Where both the application box and the toolbar are displayed, the messages of FIGS. 4A-4C can be displayed in the toolbar and not in the application box.

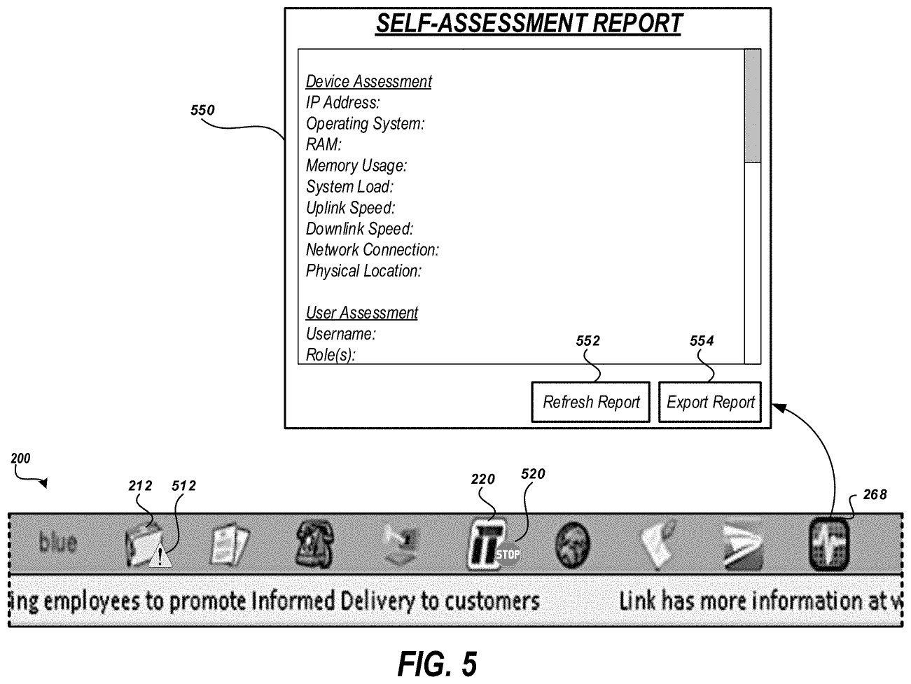

FIG. 5 depicts an example image showing an application menu, interface, or toolbar that may be generated by the system shown in FIG. 1. The application display 200 may provide a real time synthesis of information from across the enterprise representing the status of individual applications shown in the application display 200. For example, the indicator 212 may be associated with a file sharing system. If the file sharing system is experiencing technical difficulties or the workstation 180 cannot communicate with the file sharing system, a status indicator 512 may be displayed in the application display 200 in proximity to the indicator 212. In some implementations, the status indicator 512 may be a graphical overlay to the indicator 212. The difficulties may be identified by the application display 200 polling a service associated with the indicator 212. If the indicator 212 is associated with an application that executes on the workstation 180, the status of the application may be assessed by querying the location of the application or a process table for the workstation 180 indicating the status of applications executing on the workstation 180. In some implementations, the status indicator 512 may be associated with an application for trouble shooting associated item processing equipment or resource. Upon interaction with the status indicator 512, an application for viewing additional information about the status, troubleshooting the status, or the like may be activated.

A status indicator 520 may be included to identify the status of equipment associated with the application or the user. For example, the indicator 220 may be associated with item processing equipment such as a vacuum belts, tilt trays, cross belts, bomb-bay style trap doors, or other conveying mechanisms, bins, robots, trays, forklifts, stackers, printers, sorters (such as Mixed Mail Sorter (MSA-9600) manufactured or sold by Neopost or its affiliates) or other machinery configured to receive, process, and deliver items based, at least in part, on one or more control signals. The application associated with the indicator 220 may provide statistics about the sorter (e.g., uptime, number of units sorted, number of jams, etc.). If the sorter is experiencing a failure or if certain monitoring thresholds are met (e.g., number of jams, number of items processed, etc.), the status indicator 520 may be displayed as an alert to the condition.

Some applications may be included to provide feedback about the application display 200 or the workstation 180. For example, the indicator 268 may be associated with a self-assessment reporting tool. The self-assessment reporting tool may detect or collect information about the workstation or the user accessing the workstation. This information may be displayed in a report 550. The report 550 may be refreshed using a control element 552. The refreshing may cause the report 550 to be regenerated to reflect new operational state or other operational characteristic of the workstation 180. The report 550 may be used to collect information commonly needed to troubleshoot issues at the workstation 180. By providing a mechanism to collect, in a standard form, information about the workstation 180, a large enterprise can standardize the assessment and resolution of technical issues at the workstation 180.

The report 550 may be automatically transmitted using an export control element 554. The export control element 554 may be used to export the information included in the report to a help desk. The export may be directed to an automated system configured to identify anomalies in the report 550 and suggest corrections. In some implementations, the automated system may initiate contact to the user at the workstation 180 such as by calling a phone at the location of the workstation 180. Some enterprises may use virtual assistants to resolve technical issues. The export may initiate a virtual assistant who, in addition to interacting with the user, may consider the report 550 to diagnose and resolve technical issues.

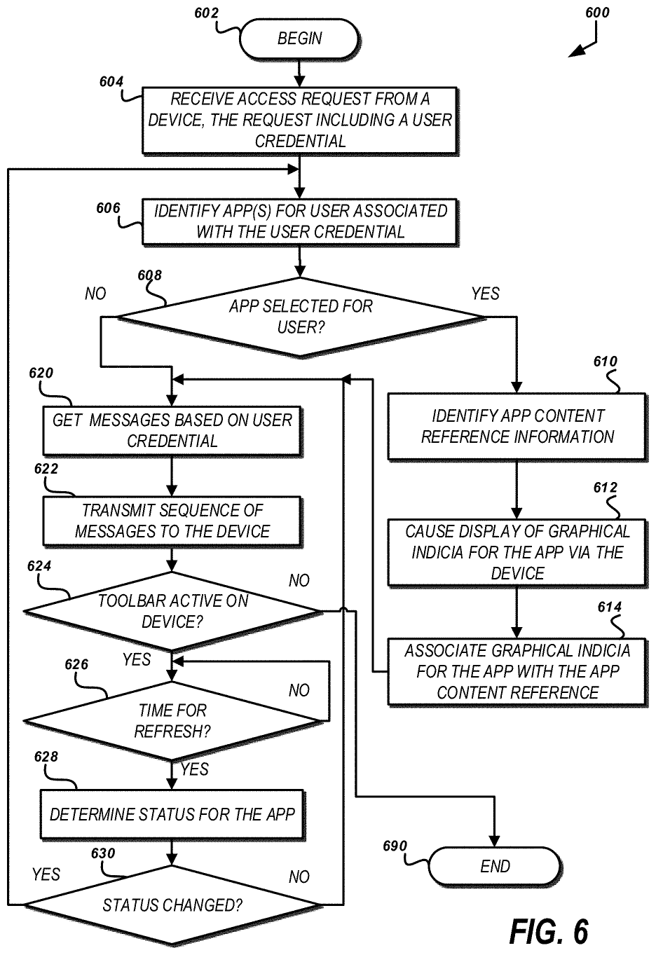

FIG. 6 is a flow diagram illustrating an example method of dynamically customizing an application. The method 600 may be performed or coordinated in whole or in part by a coordination device such as the toolbar application configuration server shown in FIG. 1. The method 600 may begin at block 602. The method 600 assumes that a user account has been accessed at least once. During an initial access, the user may perform method 300 to identify and select applications. In some instances, the user may not select applications or have relevant applications identified such as by the method 300.

At block 604, the coordination device may receive a request from a device. The request may include a user credential associated with a user accessing the workstation that will present the application box or toolbar. The credential may include a username, a security token, or other information to uniquely identify an account of the user.

At block 606, the coordination device may identify one or more toolbar applications that may be selected for the user associated with the user credential received at block 604. The identification may include querying the access control data store 120 to determine whether the user account is associated with or authorized to access and/or use any applications.

At block 608, the coordination device may determine whether any toolbar applications were identified at block 606. In the case where a user is accessing the system for the first time, the user may not be associated with any toolbar applications. In such instances, the method 600 may continue to block 620. However, if the user has previously selected toolbar applications or if default toolbar applications are associated with the user account, the method 600 may proceed to block 610.

At block 610, the coordination device may identify toolbar application content reference information. For example, if the user account is associated with a processing equipment monitoring application, the content reference information may include a URL of a service endpoint for the toolbar application. The content reference information may include user specific parameters that can be used to tailor the toolbar application to the user or their particular task, location, role, etc. For example, the URL may include placeholder parameters that can be filled using a specific attribute of the user or the workstation accessed by the user.

At block 612, the coordination device may cause display of a graphical indicia for the toolbar application via the device (e.g., workstation). The graphical indicia may be selected based on the user. For example, if the user account includes a parameter indicating high contrast, a specific icon providing a high contrast graphical display may be presented. As another example, if the user account indicates a language preference, an icon including words in the preferred language may be presented.

At block 614, the coordination device may cause the graphical indicia to be associated with the application content reference. For example, an icon may be activated to cause the workstation to access a URL or execute an application installed on the workstation. Because the content (e.g., URL or application) may change locations or parameters, the method 600 ensures that a rendering of the toolbar includes the current graphical representation, content reference, and any applicable parameters.

Having thus presented the toolbar, or in the case where no toolbar applications are associated with a user account, at block 620, the coordination device may obtain messages based at least in part on the user credential. The messages may be obtained from a message service. The coordination device may transmit a request including the user credential to the message service. Based on the user credential or user account information obtained based on the user credential, the message server may retrieve a set of messages from a message data store. The messages retrieved may be associated with distribution permissions corresponding to the attributes of the user. The set of messages may be provided with sequence information or as an ordered list. The sequencing indicates an order for presenting the messages.

In some implementations, the source of the messages may dynamically generate messages tailored to the user or based on an attribute of the user or the workstation. For example, a mail processing equipment service may be designated as a message source. The service may receive, as an input, an identifier of the user or the user's location. The service may return messages including the status of mail processing equipment or resource of interest to the user or located near the user's location. The interest of the user may be specified using one or more criteria in a profile of the user.

At block 622, the coordination device may transmit the sequence of messages to the workstation for presentation via the toolbar. The messages may be presented according to the sequence via the toolbar. The presentation may include associating the headline with an interactive control element that, when interacted with, causes the workstation to access the content associated with the headline. Accessing the content may include launching a network browsing application to access a network location. Accessing the content may include opening a file stored in memory accessible by the workstation.

At block 624, the coordination device may determine whether the toolbar is active on the device (e.g., workstation). The determination may be based on a session with the device. In some implementations, the determination may include identifying whether a session associated with an initially processed portion of the data is active. A session generally refers to a series of communications between two or more devices or servers. A session may be associated with a session identifier (e.g., a user identifier or an identifier for the workstation). The session identifier may be included in messages exchanged to allow the session participants to associate specific messages with specific toolbar activities. In this way, the coordination device can concurrently provide toolbar configuration services to multiple workstations/users by associating the user or workstation for a user with a unique session identifier.

An alternative or additional feature for determining whether the toolbar is active includes a heartbeat signal. The heartbeat signal may be a message that is transmitted from the workstation to the coordination device indicating that the toolbar is still active.

If the determination at block 624 is negative, the toolbar is no longer active on the device and the method 600 may end at block 690. However, if the determination at block 624 is affirmative, the toolbar is still actively presenting information to the user. In such instances, the underlying toolbar information (e.g., applications or messages) may change or the permissions and attributes used to configure aspects of the toolbar, toolbar applications, or messages may change. To ensure timely propagation of such changes across all workstations, a refresh time may be included. The refresh time may be specified to balance the need for propagating changes with the resources expended to identify and transmit such changes.

The refresh time may be specified as a configuration accessible to the coordination device. In some implementations, the refresh time may be dynamically assigned such as based on a user attributed. For example, some roles may have relatively static functions such as the legal department as compared to item processing operations which may change operational circumstances very quickly such as in response to weather or other item processing events. At block 626, the coordination device may determine whether the time for refresh has arrived for the toolbar presented to the user. The time may be assessed using the refresh time and if the duration of time identified by the refresh time has elapsed since presenting the toolbar, the determination at block 626 is affirmative.

In the case where the determination at block 626 is affirmative, the coordination device may, at block 628, determine a status for a toolbar application presented to the user. For example, a toolbar application record may be associated with an update time or version information. At block 630, a determination is made as to whether the status has changed. The determination may be based on comparison of the version information or the update time for the toolbar application. In some implementations, the toolbar application may be associated with a hash code. The hash code may be generated using specific values for a version of the toolbar application. For example, a hash code may be generated using at least a portion of the source code for the toolbar application. Any changes in the source code would cause a change in hash codes.

If the coordination device detects an update to a toolbar application previously presented to the user, the status for the toolbar application may be modified as compared to the currently presented toolbar application information. The status may also include an operational status of the toolbar application or status of equipment associated with the toolbar application.

If the status is determined to have changed since the original presentation of the toolbar, the method 600 may return to block 606 as described above. If the status of the toolbar applications has not changed, the method 600 may return to block 620 to reassess the messages for the user as described above.

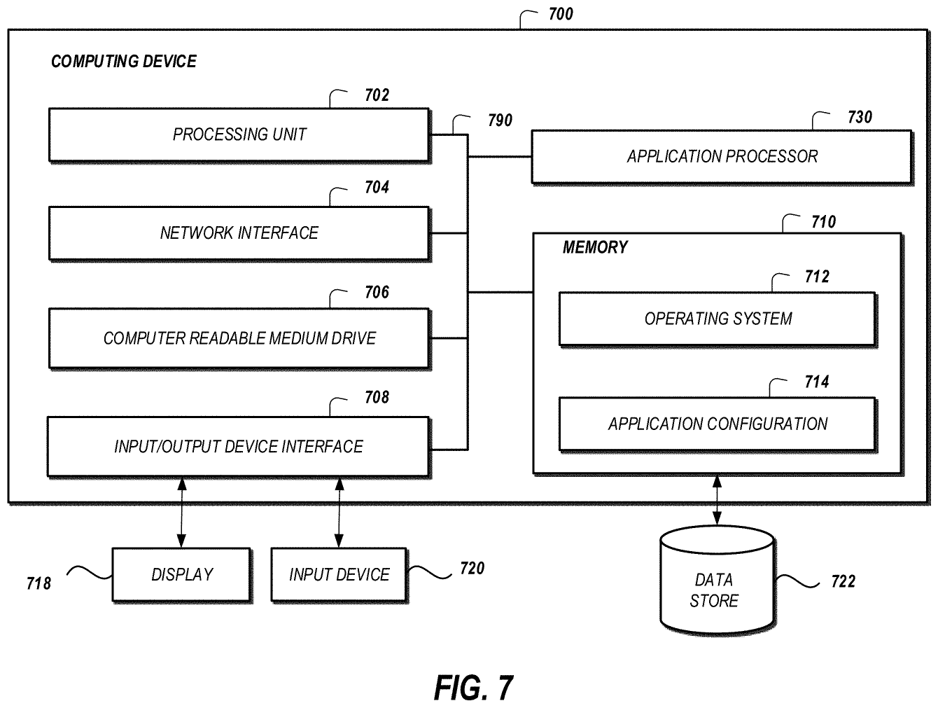

FIG. 7 is a block diagram of an embodiment of a computing device for customizing and configuring application access. The computing device 700 can be a server or other computing device, and can comprise a processing unit 702, an application processor 730, a network interface 704, a computer readable medium drive 706, an input/output device interface 708, and a memory 710. The computing device 700 may implement the features of one or more of the recommendation engine 112, the application configuration server 110, or the message server 130. The computing device 700 may be configured to perform all or a portion of the method shown in FIG. 3 or 6.

The network interface 704 can provide connectivity to one or more networks or computing systems. The network interface 704 can receive information and instructions from other computing systems or services via the network interface 704. The network interface 704 can also store data directly to memory 710. The processing unit 702 can communicate to and from memory 710 and output information to an optional display 718 via the input/output device interface 708. The input/output device interface 708 can also accept input from the optional input device 720, such as a keyboard, mouse, digital pen, microphone, mass storage device, etc.

The memory 710 may contain computer program instructions that the processing unit 702 executes in order to implement one or more embodiments. The memory 710 generally includes RAM, ROM, and/or other persistent, non-transitory computer readable media. The memory 710 can store an operating system 712 that provides computer program instructions for use by the processing unit 702 or other elements included in the computing device in the general administration and operation of the computing device 700. The memory 710 can further include computer program instructions and other information for implementing aspects of the present disclosure.

For example, in one embodiment, the memory 710 includes an application configuration 714. The application configuration 714 may include refresh time(s), location or other access information for a data store, or other information supporting the application configuration features described herein. The application configuration 714 may store specific values for a given configuration. The application configuration 714 may, in some implementations, store information for obtaining values for a given configuration. For example, a messaging service may be specified as a network location (e.g., URL) in conjunction with username and password information to access the service. In such implementations, a message including a user credential (or attribute for a user associated therewith) may be provided to the service. A response message may include the messages or a destination location (e.g., URL) for obtaining the messages, if available.

The memory 710 may also include or communicate with one or more auxiliary data stores, such as data store 722. The data store 722 may electronically store data regarding toolbars, toolbar applications, or toolbar application configurations.

The elements included in the computing device 700 may be coupled by a bus 790. The bus 790 may be a data bus, communication bus, or other bus mechanism to enable the various components of the computing device 700 to exchange information.

In some embodiments, the computing device 700 may include additional or fewer components than are shown in FIG. 7. For example, a computing device 700 may include more than one processing unit 702 and computer readable medium drive 706. In another example, the computing device 700 may not be coupled to a display 718 or an input device 720. In some embodiments, two or more computing devices 700 may together form a computer system for executing features of the present disclosure.

Aspects of the system and methods described reference a workstation or a desktop toolbar. Similar features may be included to provide applications or messages for a toolbar of a mobile device such as a smartphone, tablet computer, or the like.

The systems, methods, and devices of the disclosure each have several innovative aspects, no single one of which is solely responsible for the desirable attributes disclosed herein. In one innovative aspect a computer-implemented method performed under the control of one or more processors is provided. The computer-implemented method includes receiving, from a computing device, a toolbar request, the toolbar request including a user credential for a user of the computing device. The computer-implemented method also includes identifying an attribute of the user based at least in part on the user credential. The computer-implemented method also includes detecting an operational characteristic of the computing device; obtaining, from a first data store, application source information based at least in part on: (a) the attribute of the user, and (b) the operational characteristic of the computing device; identifying, via a second data store, a set of messages based at least in part on the attribute of the user, each message associated with a headline, content, and a sequence identifier; and causing display, via the computing device, of a toolbar including:. The computer-implemented method also includes a toolbar application area for presenting a graphical indicator for an application display, where a first interaction with the graphical indicator causes the computing device to access an application source identified by the application source information. The computer-implemented method also includes a message area for presenting headlines included in the set of message based on sequence identifiers of respective headlines, where a second interaction with a headline causes the computing device to access content associated with the headline. Other embodiments of this aspect include corresponding computer systems, apparatus, and computer programs recorded on one or more computer storage devices, each configured to perform the actions of the methods.

Implementations may include one or more of the following features. The computer-implemented method may include detecting a status of the application; and causing display of a graphical overlay to the graphical indicator, the graphical overlay identifying the status of the application. The computer-implemented method may include detecting a status of a device controlled or monitored by the application; and causing display of a graphical overlay to the graphical indicator, the graphical overlay identifying the status of the device. The computer-implemented method may include, obtaining, from a first data store, application source information by detecting a lack of applications associated with a user account for the user; comparing the attribute and the operational characteristic of the computing device to attributes of other users having user accounts associated with the application; determining a first difference between the attribute and the attributes of the other users is less than a threshold difference; associating the application with the user account for the user; and providing the application source information for the application. The computer-implemented method may include detecting a placeholder value for a user attribute within the application source information; and replacing the placeholder value with a value of the attribute for the user. For example, the placeholder value may include a uniform resource locator parameter value. As another example, the placeholder value may include a command line option value for an application installed on the computing device. The computer-implemented method may include detecting a placeholder value for a device attribute within the application source information; and replacing the placeholder value with a value of the operational characteristic for the computing device. The computer-implemented method may include recording a first time corresponding to the causing of display of the toolbar. The computer-implemented method may also include detecting occurrence of a refresh time based on a comparison of the first time with a current time. The computer-implemented method may also include identifying, via the second data store, a revised set of messages based at least in part on the attribute of the user. The computer-implemented method may also include determining that the revised set of messages is different from the set of messages. The computer-implemented method may also include causing an update to the message area to terminate display of the set of messages and initiate display of the revised set of messages. The computer-implemented method may further include detecting a status change for the application, where the status change indicates a change in the application source information; identifying, via the first data store, revised application source information; and causing an update to the application area such that the first interaction with the graphical indicator causes the computing device to access an updated application source identified by the revised application source information.

In some implementations of the computer-implemented method, the computing device is one of at least one hundred thousand computing devices in data communication with the one or more processors. In some implementations of the computer-implemented method, the user is one of at least ten thousand users having access to the computing device. In some implementations of the computer-implemented method, the application is one of at least one hundred applications having source information included in the first data store. The innovative features described may include or be implemented by hardware, a method or process, or computer software on a computer-accessible medium.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware, or as a combination of electronic hardware and executable software. To clearly illustrate this interchangeability, various illustrative components, blocks, modules, and steps have been described above generally in terms of their functionality. Whether such functionality is implemented as specialized hardware, or as specific software instructions executable by one or more hardware devices, depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A toolbar configuration management system can be or include a microprocessor, but in the alternative, the toolbar configuration management system can be or include a controller, microcontroller, or state machine, combinations of the same, or the like configured to generate and analyze indicator feedback. A toolbar configuration management system can include electrical circuitry configured to process computer-executable instructions. Although described herein primarily with respect to digital technology, a toolbar configuration management system may also include primarily analog components. For example, some or all of the toolbar configuration features described herein may be implemented in analog circuitry or mixed analog and digital circuitry. A computing environment can include a specialized computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in specifically tailored hardware, in a specialized software module executed by a toolbar configuration management system, or in a combination of the two. A software module can reside in random access memory (RAM) memory, flash memory, read only memory (ROM), erasable programmable read-only memory (EPROM), electrically erasable programmable read-only memory (EEPROM), registers, hard disk, a removable disk, a compact disc read-only memory (CD-ROM), or other form of a non-transitory computer-readable storage medium. An exemplary storage medium can be coupled to the toolbar configuration management system such that the toolbar configuration management system can read information from, and write information to, the storage medium. In the alternative, the storage medium can be integral to the toolbar configuration management system. The toolbar configuration management system and the storage medium can reside in an application specific integrated circuit (ASIC). The ASIC can reside in an access device or other monitoring device. In the alternative, the toolbar configuration management system and the storage medium can reside as discrete components in an access device or other item processing device. In some implementations, the method may be a computer-implemented method performed under the control of a computing device, such as an access device or other item processing device, executing specific computer-executable instructions.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each is present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

As used herein, the terms “determine” or “determining” encompass a wide variety of actions. For example, “determining” may include calculating, computing, processing, deriving, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing, and the like.

As used herein, the term “selectively” or “selective” may encompass a wide variety of actions. For example, a “selective” process may include determining one option from multiple options. A “selective” process may include one or more of: dynamically determined inputs, preconfigured inputs, or user-initiated inputs for making the determination. In some implementations, an n-input switch may be included to provide selective functionality where n is the number of inputs used to make the selection.

As used herein, the terms “provide” or “providing” encompass a wide variety of actions. For example, “providing” may include storing a value in a location for subsequent retrieval, transmitting a value directly to the recipient, transmitting or storing a reference to a value, and the like. “Providing” may also include encoding, decoding, encrypting, decrypting, validating, verifying, and the like.

As used herein, the term “message” encompasses a wide variety of formats for communicating (e.g., transmitting or receiving) information. A message may include a machine readable aggregation of information such as an XML document, fixed field message, comma separated message, or the like. A message may, in some implementations, include a signal utilized to transmit one or more representations of the information. While recited in the singular, it will be understood that a message may be composed, transmitted, stored, received, etc. in multiple parts.

All references cited herein are incorporated herein by reference in their entirety. To the extent publications and patents or patent applications incorporated by reference contradict the disclosure contained in the specification, the specification is intended to supersede and/or take precedence over any such contradictory material.

The term “comprising” as used herein is synonymous with “including,” “containing,” or “characterized by,” and is inclusive or open-ended and does not exclude additional, unrecited elements or method steps.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention as embodied in the attached illustrative claims.

1. A computer-implemented method comprising:
under control of one or more processors,
receiving, from a computing device, an application request, the application request including a user credential for a user of the computing device;
identifying an attribute of the user based at least in part on the user credential;
detecting an operational characteristic of the computing device;
obtaining, from a first data store, application source information based at least in part on: (a) the attribute of the user, and (b) the operational characteristic of the computing device; and
causing display, via the computing device, an interface comprising an application area for presenting a graphical indicator for an application, wherein a first interaction with the graphical indicator causes the computing device to access a application source identified by the application source information.

2. The computer-implemented method of claim 1, further comprising:
detecting a status of the application; and
causing display of a graphical overlay to the graphical indicator, the graphical overlay identifying the status of the application.

3. The computer-implemented method of claim 1, further comprising:
detecting a status of a device controlled or monitored by the application; and
causing display of a graphical overlay to the graphical indicator, the graphical overlay identifying the status of the device.

4. The computer-implemented method of claim 1, wherein obtaining, from a first data store, application source information based at least in part on: (a) the attribute of the user, and (b) the operational characteristic of the computing device comprises:
detecting a lack of applications associated with a user account for the user;
comparing the attribute and the operational characteristic of the computing device to attributes of other users having user accounts associated with the application;
determining a first difference between the attribute and the attributes of the other users is less than a threshold difference;
associating the application with the user account for the user; and
providing the application source information for the application.

5. The computer-implemented method of claim 1, further comprising:
detecting a placeholder value for a user attribute within the application source information; and
replacing the placeholder value with a value of the attribute for the user.

6. The computer-implemented method of claim 5, wherein the placeholder value is a uniform resource locator parameter value.

7. The computer-implemented method of claim 5, wherein the placeholder value is a command line option value for an application installed on the computing device.

8. The computer-implemented method of claim 1, further comprising:
detecting a placeholder value for a device attribute within the application source information; and
replacing the placeholder value with a value of the operational characteristic for the computing device.

9. The computer-implemented method of claim 1, further comprising:
identifying, via a second data store, a set of messages based at least in part on the attribute of the user, each message associated with a headline, content, and a sequence identifier; and
causing display, via the computing device, an interface comprising a message area for presenting headlines included in the set of message based on sequence identifiers of respective headlines, wherein a second interaction with a headline causes the computing device to access content associated with the headline.

10. The computer-implemented method of claim 9, further comprising:
recording a first time corresponding to the causing of display of the interface;
detecting occurrence of a refresh time based on a comparison of the first time with a current time;
identifying, via the second data store, a revised set of messages based at least in part on the attribute of the user;
determining that the revised set of messages is different from the set of messages; and
causing an update to the message area to terminate display of the set of messages and initiate display of the revised set of messages.

11. The computer-implemented method of claim 1, further comprising:
detecting a status change for the application, wherein the status change indicates a change in the application source information;
identifying, via the first data store, revised application source information; and
causing an update to the application area such that the first interaction with the graphical indicator causes the computing device to access an updated application source identified by the revised application source information.

12. The computer-implemented method of claim 1, wherein the computing device is one of at least one hundred thousand computing devices in data communication with the one or more processors.

13. The computer-implemented method of claim 1, wherein the user is one of at least ten thousand users having access to the computing device.

14. The computer-implemented method of claim 1, wherein the application is one of at least one hundred applications having source information included in the first data store.

15. The computer-implemented method of claim 1, wherein the operational characteristic of the computing device comprises a peripheral device attached to the computing device.

16. The computer-implemented method of claim 15, wherein detecting the operational characteristic comprises:
transmitting a peripheral request to the computing device; and
receiving a message from the computing device including the operational characteristic of the computing device.

17. A system for using computer applications comprising:
a user interface configured to receive, from a user's computing device, an application request, the application request including a user credential for a user of the computing device;
a server in communication with the user interface, the server configured to:
identify an attribute of the user based at least in part on the user credential;
detect an operational characteristic of the computing device;
obtain, from a first data store, application source information based at least in part on: (a) the attribute of the user, and (b) the operational characteristic of the computing device; and
cause display, via the user interface, an application area for presenting a graphical indicator for an application, wherein a first interaction with the graphical indicator causes the computing device to access a application source identified by the application source information.

18. The system of claim 17, wherein the server is further configured to:
query a second data store, using the attribute of the user, a set of messages, each of the set of messages being associated with a headline, content, and a sequence identifier; and
cause display, via the user interface, a message area for presenting headlines included in the set of message based on sequence identifiers of respective headlines, wherein a second interaction with a headline causes the computing device to access content associated with the headline.

19. The system of claim 17, wherein the server is further configured to:
detect a status of the application; and
cause display of a graphical overlay to the graphical indicator, the graphical overlay identifying the status of the application.

20. The system of claim 17, wherein the server is further configured to:
detect a status of a device controlled or monitored by the application; and
cause display of a graphical overlay to the graphical indicator, the graphical overlay identifying the status of the device.
